(19) United States
(12) Patent Application Publication
(10) Pub. No.: US 2025/0079925 A1
(43) Pub. Date: Mar. 6, 2025

(54) MOTOR AND ELECTRICAL PRODUCT

(71) Applicant: NIDEC CORPORATION, Kyoto (JP)

(72) Inventors: Zhipeng LI, Dalian (CN); Yan LUO, Dalian (CN); Jiquan LIU, Dalian (CN)

(21) Appl. No.: 18/779,426

(22) Filed: Jul. 22, 2024

(30) Foreign Application Priority Data
Aug. 29, 2023 (CN) 202311101287.2

(51) Int. Cl. H02K 3/50; H02K 1/18; H02K 3/34

(52) U.S. Cl. CPC H02K 3/50; H02K 1/18; H02K 3/345; H02K 2203/09

(57) ABSTRACT

A motor includes a stator core and a busbar assembly on an axial side of the stator core, the busbar assembly includes a busbar holder and busbars each partially embedded into the busbar holder, each busbar includes a claw portion exposed from the busbar holder, teeth of the stator core are insulated from a coil wound on the teeth through an insulator, the busbar holder includes an annular main body portion, and the main body portion is radially opposite to the insulator. By arranging the main body portion of the busbar holder to be radially opposite to the insulator, the busbar holder does not occupy an additional axial dimension, thus reducing an axial length of the motor and miniaturizing the motor.

### CROSS-REFERENCE TO RELATED APPLICATIONS

The present invention claims priority under 35 U.S.C. § 119 to Chinese Patent Application No. 202311101287.2, filed on Aug. 29, 2023, the entire contents of which are hereby incorporated herein by reference.

### 1. FIELD OF THE INVENTION

The present application relates to the electromechanical field, in particular to motors and electrical products.

### 2. BACKGROUND

In an existing motor structure, a busbar holder is arranged on an axially upper side of the insulator, and claw portions of the busbar holder are supported on a stator core. In general cases, the claw portions of the busbar holder are fixed to the back of the stator core, that is, to a radially outer side of teeth of the stator core.

It should be noted that the above introduction to the technical background is only for the convenience of a clear and complete description of the technical solutions of the present application, and for the convenience of understanding by those skilled in the art. It cannot be considered that the above technical solutions are known to those skilled in the art just because these solutions are described in the background section of the present application.

### SUMMARY

The inventors have discovered that in the existing motor structure, since a busbar holder is fixed to the back of a stator core through claw portions, the busbar holder occupies an axial dimension, resulting in a larger axial dimension of the motor.

According to an example embodiment of the present application, a motor includes a stator core and a busbar assembly on an axial side of the stator core, in which the busbar assembly includes a busbar holder and busbars each partially embedded into the busbar holder. Each busbar includes a claw portion exposed from the busbar holder. Teeth of the stator core are insulated from a coil wound on the teeth through an insulator. The busbar holder includes an annular main body portion, and the main body portion is radially opposite to the insulator.

In one or more example embodiments, the main body portion of the busbar holder is located on a radially outer side of the insulator.

In one or more example embodiments, the opening of each claw portion opposes a radially inner side.

In one or more example embodiments, an inner peripheral surface of the main body portion of the busbar holder includes a convex portion, and an outer peripheral surface of a portion of the insulator radially opposite to the main body portion includes a concave portion that matches the convex portion.

In one or more example embodiments, the busbar portion embedded into the main body portion has a sheet-shaped structure, which includes an extended surface parallel or substantially parallel to a central axis of the motor.

In one or more example embodiments, a projection of the busbar portion embedded into the main body portion in an axial direction is located on a same circumference of the same radial dimension.

In one or more example embodiments, a plurality of busbars is provided, and the claw portions of the plurality of busbars have a same axial height.

In one or more example embodiments, the main body portion of the busbar holder is located on a radially inner side of the insulator.

In one or more example embodiments, the opening of each claw portion opposes a radially outer side.

According to another example embodiment of the present application, an electrical product includes the motor according to any of the example embodiments described above.

The example embodiments of the present application will be disclosed in detail with reference to the following description and accompanying drawings. It should be understood that the example embodiments of the present application are not limited thereby in scope. The example embodiments of the present application encompass many changes, modifications and equivalents within the scope of the spirit and terms of the appended claims.

Features described and/or illustrated with respect to one example embodiment may be used in the same or similar manner in one or more other example embodiments, in combination with, or instead of features in other implementations.

The above and other elements, features, steps, characteristics and advantages of the present disclosure will become more apparent from the following detailed description of the example embodiments with reference to the attached drawings.

### BRIEF DESCRIPTION OF THE DRAWINGS

The included accompanying drawings are used to provide a further understanding of the example embodiments of the present application, which constitute a part of the description to illustrate the implementations of the present application, and explain the principle of the present application together with the text description. Apparently, the accompanying drawings in the following description are only some example embodiments of the present application, and those of ordinary skill in the art can also obtain other accompanying drawings according to these drawings without paying creative work. In the accompanying drawings:

FIG. 1 is a schematic diagram of part of assemblies of a motor according to an example embodiment of the present application.

FIG. 2 is a top view of part of assemblies of the motor shown in FIG. 1.

FIG. 3 is a schematic diagram of a busbar assembly according to an example embodiment of the present application.

FIG. 4 is a schematic diagram of an insulator according to an example embodiment of the present application.

FIG. 5 is a schematic diagram of a plurality of busbars of a busbar assembly according to an example embodiment of the present application.

FIG. 6 is a top view of a plurality of busbars of a busbar assembly according to an example embodiment of the present application.

FIG. 7 is a side view of a plurality of a plurality of busbars of a busbar assembly according to an example embodiment of the present application.

### DETAILED DESCRIPTION

The foregoing and other features of the present application will become apparent from the following description with reference to the accompanying drawings. In the description and accompanying drawings, specific implementations of the present application are disclosed, which indicate some implementations in which the principles of the present application can be adopted. It should be understood that the present application is not limited to the described implementations. On the contrary, the present application includes all modifications, variations and equivalents that fall within the scope of the appended claims.

In the example embodiments of the present application, the term “and/or” includes any one and all combinations of one or more of the associated listed terms. The terms “comprising”, “including”, “having” and the like refer to the presence of stated features, elements, component or assemblies, but do not exclude the presence or addition of one or more other features, elements, components or assemblies.

In the example embodiments of the present application, the singular forms “a”, “this” and the like may include plural forms, which should be broadly understood as “a kind” or “a class”, but not limited to the meaning of “one”. In addition, the term “the” should be understood to include both the singular form and the plural form, unless the context clearly dictates otherwise. Furthermore, the term “according to” should be understood as “at least in part according to . . . ”, and the term “based on” should be understood as “at least in part based on . . . ”, unless the context clearly indicates otherwise.

In addition, in the following description of the present application, for the convenience of description, a direction extending along a central axis OO′ of a motor or a direction parallel to this direction is referred to as an “axial direction”, a radius direction centered on the central axis OO′ is referred to as a “radial direction”, a direction around the central axis OO′ is referred to as a “circumferential direction”, a side away from the central axis OO′ in the radius direction is referred to as a “radially outer side”, a side close to the central axis OO′ in the radius direction is referred to as a “radially inner side”, a direction of the bottom of a motor casing pointing to an opening is referred to as an “axial side” or “axially upper side” or “upper side” or “above”, and a direction of the opening of the motor casing pointing to the bottom is referred to as “the other axial side”, “axially lower side”, “lower side” or “below”. However, it is worth noting that these are for illustrative convenience only and do not limit the orientation of the motor when used and manufactured.

Various implementations of the example embodiments of the present application will be described below with reference to the accompanying drawings.

This example embodiment of the present application provides a motor.

In this example embodiment of the present application, this motor is mounted on an automobile, for example, and is used in a braking system. In addition, this motor may also be used for purposes other than braking. For example, this motor may also be used as a driving source for other parts of the automobile, such as an engine cooling fan or an oil pump. In addition, this motor may also be mounted on home appliances, office automation equipment, medical equipment, etc. to generate various driving forces.

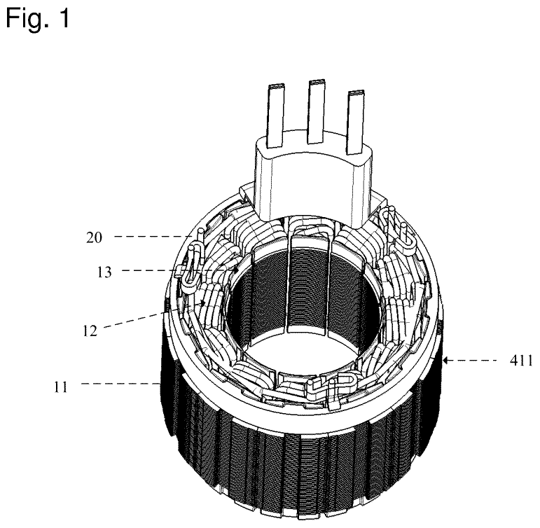

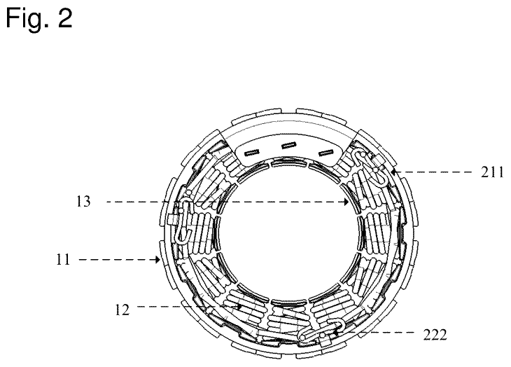

FIG. 1 is a schematic diagram of part of assemblies of a motor according to an example embodiment of the present application. FIG. 2 is a top view of part of assemblies of the motor shown in FIG. 1.

As shown in FIG. 1 and FIG. 2, the motor according to this example embodiment of the present application includes a stator core 11 and a busbar assembly 20 arranged on an axial side of the stator core 11.

In this example embodiment of the present application, teeth (not shown in the figures) of the stator core 11 are insulated from a coil 12 wound around the teeth (not shown in the figures) through an insulator 13. The stator core 11, the coil 12 and the insulator 13 constitute the stator.

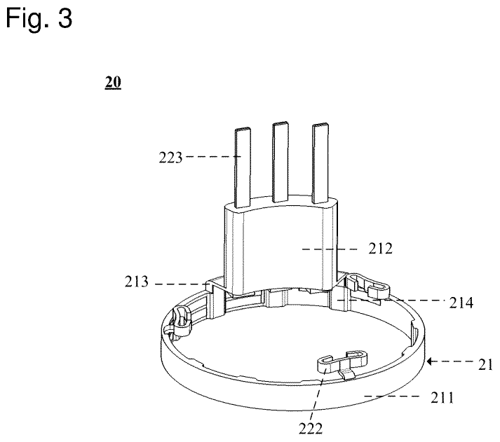

FIG. 3 is a schematic diagram of a busbar assembly 20 according to an example embodiment of the present application. As shown in FIG. 3, in this example embodiment of the present application, the busbar assembly 20 includes a busbar holder 21 and busbars 22 each partially embedded into the busbar holder 21. A plurality of busbars 22 is provided. That is, a part of each of the plurality of busbars 22 is embedded into the busbar holder 21, and the other part of each of the plurality of busbars 22 is exposed from the busbar holder 21.

As shown in FIG. 3, each busbar 22 includes a claw portion 222 exposed from the busbar holder 21. Each claw portion 222 is formed substantially in an ear shape when viewed from an axial direction. Each claw portion 222 has an opening for fixing a terminal of the coil 12.

In this example embodiment of the present application, the busbar holder 21 includes an annular main body portion 211. As shown in FIG. 2, the annular main body portion 211 is radially opposite to the insulator 13. That is, when viewed from the radial direction, the main body portion 211 of the busbar holder 21 is projected onto the insulator 13.

Therefore, by arranging the main body portion 211 of the busbar holder 21 to be radially opposite to the insulator 13, the busbar holder 21 does not occupy an additional axial dimension, thereby reducing an axial length of the motor and miniaturizing the motor.

In some example embodiments, as shown in FIG. 2, the main body portion 211 of the busbar holder 21 is located on a radially outer side of the insulator 13, and accordingly, the opening of each claw portion 222 opposes a radially inner side. Therefore, this facilitates the connection between the terminals of the coil 12 and the claw portions. However, the present application is not limited thereto. For example, the main body portion 211 may also be located on the radially inner side of the insulator 13, and accordingly, the opening of each claw portion 222 opposes a radially outer side. Therefore, the axial length of the motor 1 can be further reduced, and the motor 1 can be miniaturized.

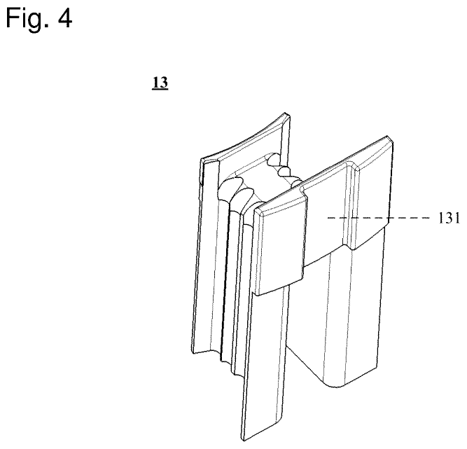

FIG. 4 is a schematic diagram of an insulator 13 according to an example embodiment of the present application.

In some example embodiments, as shown in FIG. 4, an outer peripheral surface of the insulator 13 has a concave portion 131. As shown in FIG. 3, an inner peripheral surface of the main body portion 211 of the busbar holder 21 has a convex portion 214. The convex portion 214 and the concave portion 131 are radially opposed and mutually matched. Thus, the busbar holder 21 may be fixed in a circumferential direction, and the busbar holder can be prevented from moving in the circumferential direction.

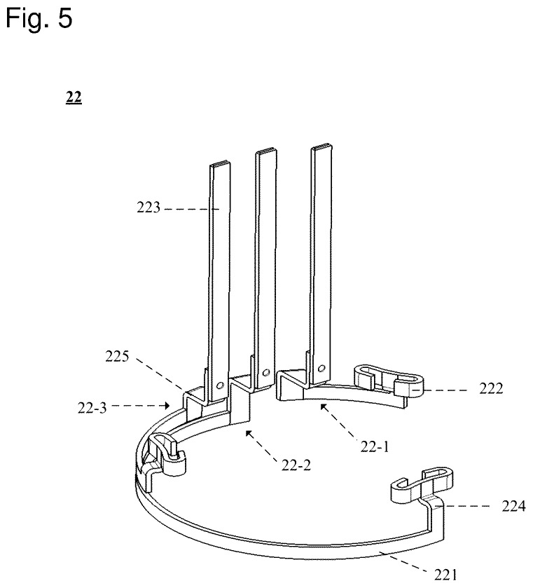

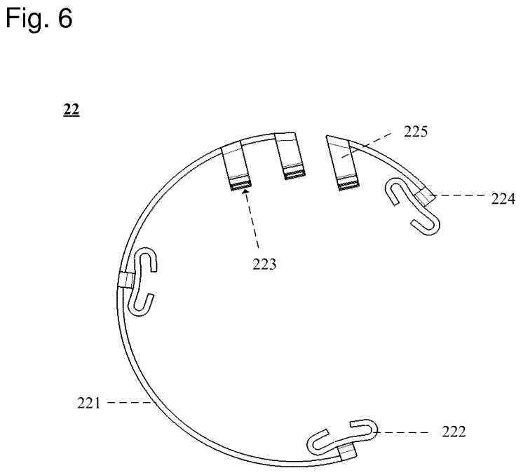

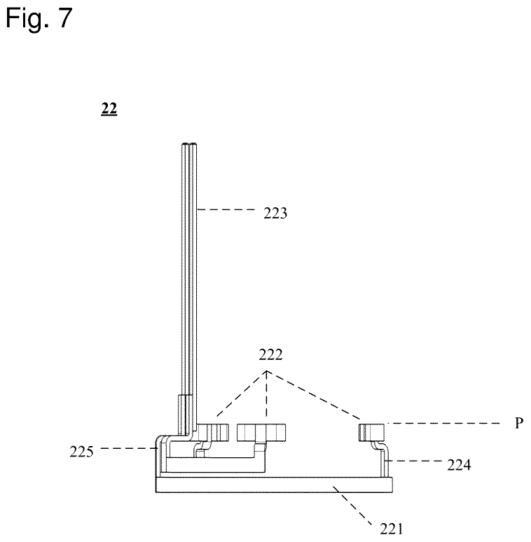

FIG. 5 is a schematic diagram of a plurality of busbars 22 of a busbar assembly according to an example embodiment of the present application. FIG. 6 is a top view of a plurality of busbars 22 of a busbar assembly according to an example embodiment of the present application. FIG. 7 is a side view of a plurality of busbars 22 of a busbar assembly according to an example embodiment of the present application.

As shown in FIGS. 5 to 7, in some example embodiments, the busbar portion (referred to as a busbar main body portion 221) embedded into the busbar holder 21 is of a sheet-shaped structure that extends along the circumferential direction. When viewed from the axial direction, the busbar portion is approximately formed into a circular arc shape and has an extended surface parallel to a central axis OO′ of the motor. That is, the busbar main body portion 221 is vertically arranged in an axial direction and extends in a longitudinal direction. Therefore, the radial thickness of the busbar holder 21 can be reduced, which is beneficial for controlling a radial dimension of the motor.

In some example embodiments, as shown in FIG. 3, the main body portion 211 of the busbar holder 21 may completely cover the busbar main body portion 221, or may partially cover the busbar main body portion 221. That is, part of the busbar main body portion 221 is embedded into the main body portion 211 of the busbar holder 21.

Therefore, the busbar portion embedded into the main body portion 211 of the busbar holder 21 is of a sheet-shaped structure, which has an extended surface parallel to the central axis OO′ of the motor. Therefore, the radial thickness of the busbar assembly 20 can be reduced, thereby reducing the radial dimension of the motor.

In some example embodiments, as shown in FIG. 6, a projection of a portion (the busbar main body portion 221) of each busbar 22 embedded into the main body portion 211 of the busbar holder 21 in the axial direction is a portion of a circular ring having the same radial dimension. That is, the projections of the portions (the busbar main body portion 221) of the busbars 22 that are embedded into the main body portion 211 of the busbar holder 21 in the axial direction are located on the same circumference. Therefore, the radial thickness of the busbar assembly 20 can be further reduced, thereby reducing the radial dimension of the motor.

In some example embodiments, as shown in FIG. 5, the busbar assembly 20 includes three busbars 22. In FIG. 5, they are marked as 22-1, 22-2, and 22-3, but the present application is not limited thereto. The number of the busbars 22 may be other as required.

In some example embodiments, as shown in FIG. 7, the claw portions 222 of the busbars 22-1, 22-2, and 22-3 have the same height in the axial direction. As shown in FIG. 7, they are all at a position P. Therefore, it can facilitate a fixing operation of coil terminals, and prevent the main body portion (including the claw portions) of the busbar assembly 20 from occupying an additional axial space, thereby further reducing the axial dimension of the motor.

For example, as shown in FIGS. 5 to 7, each busbar 22 may further include a busbar terminal 223, a first connecting portion 224 connecting the busbar main body portion 221 and the claw portion 222, and a second connecting portion 225 connecting the busbar main body portion 221 and the busbar terminal 223.

In the above example, the first connecting portion 224 may extend from an axial upper surface of the main body portion 221 to an axial upper side, and a front end portion of the first connecting portion 224 may bend toward a radially inner side and is connected to the claw portion 222. The second connecting portion 225 may extend from the axial upper surface of the main body portion 221 to a radial inner side, and a front end portion of the second connecting portion 225 may bend toward an axial upper side and is connected to the busbar terminal 223. In addition, the busbar terminal 223 may be of a sheet-shaped structure that extends linearly toward the axial upper side and used for connecting to an external power supply.

For another example, as shown in FIG. 3, the busbar holder 21 may further include a terminal guide portion 212 and a connecting portion 213.

In the above example, the connecting portion 213 may extend from the axial upper surface of the main body portion 211 to the radially inner side and used for connecting to the terminal guide portion 212. The terminal guide portion 212 may extend in the axial direction and is provided with a through hole that penetrates in the axial direction. A lower portion of the busbar terminal 223 of the busbar 22 is embedded into the through hole, and an upper portion of the terminal 223 extends from the through hole.

In the above example embodiment, only the structures related to the motor in this example embodiment of the present application are described. The motor may also include other structures, such as a rotor, and a casing. Details may refer to the related technologies, and are omitted here.

The motor of this example embodiment of the present application has been described above through different example embodiments from different perspectives. The above example embodiments may be combined in any form, which will be omitted here. In addition, the above content is only an exemplary description of the present application, but the present application is not limited thereto, and appropriate variations can also be made on the basis of the above implementations.

According to the motor of the above example embodiment, by arranging the main body portion of the busbar holder to be radially opposite to the insulator, the busbar holder does not occupy an additional axial dimension, thereby reducing an axial length of the motor and miniaturizing the motor.

This example embodiment of the present application provides an electrical product. The electrical product includes the motor described in the example embodiment of the first aspect. Since the structure of the motor has been described in detail in the example embodiment of the first aspect, its content is incorporated here, which will be omitted here.

In this example embodiment of the present application, the electrical product may be any device or equipment using a motor, including various household equipment, office automation equipment, industrial equipment, vehicle-mounted devices or components in various equipment, etc., such as a brake component using a motor.

It is worth noting that the above content is only an exemplary description of the present application, but the present application is not limited thereto, and appropriate variations may also be made on the basis of the above implementations. In addition, the above is only an illustrative description of various components, but the present application is not limited to this. The specific content of various components may also refer to the related technologies. In addition, components that are not shown in the drawings may be added, or one or more components in the drawings may be reduced.

The present application is described above in conjunction with specific implementations, but those skilled in the art should be clear that these descriptions are exemplary and are not intended to limit the protection scope of the present application. Those skilled in the art may make various variations and modifications to the present application according to the principles of the present application, and these variations and modifications are also within the scope of the present application.

The preferred implementations of the present application are described above with reference to the accompanying drawings. Many features and advantages of these implementations are clear according to the detailed description. Therefore, the accompanying claims are intended to cover all these features and advantages that fall within the true spirit and scope of these implementations. Furthermore, since those skilled in the art is prone to think of many modifications and changes, it is not intended to limit the implementations of the present application to the precise structure and operations shown and described, but to cover all suitable modifications and equivalents that fall within its scope.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a stator core; and
a busbar assembly on an axial side of the stator core; wherein
the busbar assembly includes a busbar holder and busbars each partially embedded into the busbar holder;
each busbar includes a claw portion exposed from the busbar holder;
teeth of the stator core are insulated from a coil wound on the teeth through an insulator;
the busbar holder includes an annular main body portion; and
the main body portion is radially opposite to the insulator.

2. The motor according to claim 1, wherein the main body portion of the busbar holder is located on a radially outer side of the insulator.

3. The motor according to claim 2, wherein an opening of each claw portion opposes a radially inner side.

4. The motor according to claim 2, wherein
an inner peripheral surface of the main body portion of the busbar holder includes a convex portion; and
an outer peripheral surface of a portion of the insulator radially opposite to the main body portion includes a concave portion that matches the convex portion.

5. The motor according to claim 1, wherein the busbar portion embedded into the main body portion of the busbar holder has a sheet-shaped structure, which includes an extended surface parallel or substantially parallel to a central axis of the motor.

6. The motor according to claim 1, wherein a projection of the busbar portion embedded into the main body portion of the busbar holder in an axial direction is located on a same circumference of the same radial dimension.

7. The motor according to claim 1, wherein a plurality of busbars is provided, and the claw portions of the plurality of busbars have a same axial height.

8. The motor according to claim 1, wherein the main body portion of the busbar holder is located on a radially inner side of the insulator.

9. The motor according to claim 8, wherein an opening of each claw portion opposes a radially outer side.

10. An electrical product comprising the motor according to claim 1.
